(19) United States
(12) Patent Application Publication
(10) Pub. No.: US 2026/0243311 A1
(43) Pub. Date: Aug. 20, 2026

(54) Drive Unit for a Vehicle

(71) Applicant: ZF Friedrichshafen AG, Friedrichshafen (DE)

(72) Inventor: Oliver Löchte, Wangen (DE)

(21) Appl. No.: 19/161,863

(22) PCT Filed: Feb. 23, 2024
(86) PCT No.: PCT/EP2024/054673

§ 371 Date: Sep. 3, 2025

(30) Foreign Application Priority Data
Mar. 3, 2023 (DE) 10 2023 201 925.6

(51) Int. Cl. F16D 7/02; B62M 6/55; B62M 11/02; F16H 49/00

(52) U.S. Cl. CPC F16D 7/021; B62M 6/55; B62M 11/02; F16H 49/001

(57) ABSTRACT

A propulsion device for a vehicle includes an electric motor, a crank axle, a driven element, a crank axle output element coupled to the crank axle and couplable to the driven element, a stationary element, and a gearing having a predetermined transmission ratio, with an input side of the gearing being coupled to an output element of the electric motor, and with the gearing having a gearing output element couplable to the driven element. The device further includes a torque support component having one or more outwardly facing surface sections, at least one of which has an outwardly curved contour. Additionally, the device includes a torque limiting assembly for limiting a torque between the electric motor and the driven element to a permissible torque by allowing the torque support component to rotate relative to the stationary element when the torque exceeds a predetermined maximum torque.

### CROSS-REFERENCE TO RELATED APPLICATION

The present application is related and has right of priority to German Patent Application No. 10 2023 201 925.6 filed on Mar. 3, 2023 and is a nationalization of PCT/EP2024/054673 filed in the European Patent Office on Feb. 23, 2024, both of which are incorporated by reference in their entirety for all purposes.

### FIELD OF THE INVENTION

The present invention relates generally to a propulsion device or drive unit for a vehicle which is propelled at least intermittently by an electric motor and at least intermittently by muscle power. In particular, the invention relates generally to a propulsion device for a vehicle, in which drive power from an electric motor and drive power generated by muscle power are combinable and used to propel the vehicle. The invention generally relates, in particular, to a propulsion device in which deviations of concentricity of elements inside the propulsion device have reduced effects on the operation and the durability of the propulsion device.

### BACKGROUND

In the prior art according to DE 10 2015 100 676B3, a propulsion device for a bicycle or a pedelec is described. In such propulsion device, an electric motor is used to generate propulsive force for the vehicle. To do this, the electric motor is coupled to an output element of the propulsion device via a strain wave gearing.

In the prior art according to EP 2 976 551B1, a pin ring gearing is described, which is a strain wave gearing with which a predetermined transmission ratio is provided for transmitting a propulsive force.

### SUMMARY OF THE INVENTION

A propulsion device for a vehicle includes an electric motor for at least intermittently propelling the vehicle by supplying electrical power to the electric motor, a crank axle for receiving muscle power to at least intermittently propel the vehicle by muscle power, and a driven element, via which propulsive force from the propulsion device for propelling the vehicle is deliverable from the propulsion device. The propulsion device further includes a gearing with a predetermined transmission ratio, which is coupled on the input side to an output element of the electric motor and is couplable on the output side to the driven element of the propulsion device via a gearing output element. Further, the propulsion device includes a crank axle output element coupled to the crank axle, which is couplable to the driven element of the propulsion device. The propulsion device has a torque limiting assembly for limiting a torque acting in the force transmission path between the electric motor and the driven element. If a predetermined maximum torque is exceeded, the torque limiting assembly allows a torque support component to rotate relative to a stationary element of the propulsion device, such that the torque acting on the rotor of the electric motor is limited to a permissible torque. At least one of axially and radially outwardly facing surface sections of the torque support component has an outwardly curved contour.

The propulsion device is fixedly mountable on the vehicle. The propulsion device may be an assembly and mountable on the vehicle such that a compact design is made possible. The vehicle may be provided for transporting persons. In addition, the vehicle may be provided for transporting goods. The vehicle may be a single-track vehicle. Alternatively, the vehicle may be a multi-track vehicle. The vehicle may be an e-bike or a pedelec, in which muscle power as well as propulsive force of an electrical drive are usable to propel the vehicle. An electrical energy storage device is providable, with which the electric motor of the propulsion device is operable. Furthermore, a control device is providable, with which the operation of the electric motor is controllable in an open loop. The vehicle may have pedals, which are mounted on the crank axle to enable the introduction of muscle power.

According to one example embodiment, the torque support component may be coupled to a housing of the propulsion device for supporting a reaction torque, wherein the torque limiting assembly is in the force transmission path between the torque support component and the housing in order to limit the support torque to a predetermined maximum support torque.

According to one example embodiment, if the predetermined maximum support torque is exceeded, the torque limiting assembly allows the torque support component of the gearing to rotate relative to a stationary element, such that the torque acting on the rotor of the electric motor in response to the reaction torque is limited to a permissible torque.

The torque acting on the rotor of the electric motor may result from the drive of the electric motor and the transmission function of the gearing. In this case, the torque acting on the rotor of the electric motor corresponds to the present drive torque of the electric motor. The torque acting on the rotor of the electric motor may additionally, or alternatively, result from an action on the gearing. In particular, if there is action on the output side of the gearing, at least a portion thereof is transmitted onto the rotor of the electric motor via the gearing. Additionally, or alternatively, torque shocks that act on the output side of the gearing are transmittable onto the rotor of the electric motor via the gearing.

Furthermore, the torque acting on the rotor of the electric motor may result from the dynamic mode of operation of the propulsion device. In particular, the torque acting on the rotor of the electric motor may result from a dynamic mode of operation in conjunction with an inertia of the participating moving elements. The torque on the rotor of the electric motor may be subjected to strong fluctuations when there are sharp changes in rotational speed at the electric motor or fluctuations in rotational speed are induced on the output side of the gearing.

According to one example embodiment, the torque limiting assembly may include a friction clutch arrangement, which is preloadable by a preloading element such that, if a predetermined maximum torque applied at the torque limiting assembly is exceeded, a slip is induced in the friction clutch arrangement, such that the torque limiting assembly allows a relative motion between the torque support component and the stationary element.

The friction clutch arrangement may be one or multiple friction clutch plates. Alternatively, the friction clutch arrangement may be one or more cone elements. The friction clutch arrangement may be axially symmetrical to an axis of symmetry of the propulsion device.

According to one example embodiment, the torque support component is rotationally symmetrical and has at least one radially outwardly facing surface section on an outer periphery, which surface section engages with an inner periphery of the stationary element via the outwardly curved contour. The outwardly curved may be radially outwardly curved from at least one of the radially outwardly facing surface sections. Furthermore, the outwardly curved contour may be axially outwardly curved from at least one of the axially outwardly facing surface sections. The curved contour may be rotationally symmetrical with respect to an axis of symmetry of the torque support component. The curved contour of at least one of the radially outwardly facing surface sections may completely encircle the torque support component. The curved contour of at least one of the radially outwardly facing surface sections may have a diameter varying along the axial direction of the torque support component with a maximum diameter in the axially central region of the curved contour. The curved contour of at least one of the radially outwardly facing surface sections may be rotationally symmetrical with respect to an axis of symmetry of the torque support component. The curved contour of at least one of the radially outwardly facing surface sections may completely encircle the torque support component. The curved contour of at least one of the radially outwardly facing surface sections may be provided on a corresponding end section of the torque support component. The curved contour of at least one of the radially outwardly facing surface sections may be a circular protrusion on the surface section, which has an extent varying in the radial direction of the torque support component with a maximum axial extent in the radially central region of the curved contour.

According to one example embodiment, the torque support component is rotationally symmetrical and at least one radially outwardly facing surface section is provided on the torque support component, which surface section is engageable with a radially inwardly facing surface of a holder of the preloading element of the torque limiting assembly.

According to one example embodiment, the torque support component has two radially outwardly facing surface sections on an outer periphery, which surface sections are axially spaced apart from one another.

According to one example embodiment, the torque support component extends axially and has at least one axially outwardly facing surface section, which surface section is engageable with a radial section of the stationary element via the outwardly curved contour.

According to one example embodiment, the torque support component extends axially and has at least one axially outwardly facing surface section, which surface section is engageable with a radial section of a holder of the preloading element of the torque limiting assembly via the outwardly facing surface section, such as a curved contour.

According to one example embodiment, two axially outwardly facing surface sections are provided on the torque support component, which surface sections may be provided on the axial end sections of the torque support component.

According to one example embodiment, the outwardly curved contour of at least one of the surface sections has a predetermined radius of curvature. For the curved contour of the radially outwardly facing surface section, the predetermined radius of curvature is a radius of the contour on the outer periphery of the torque support component as viewed in a longitudinal section of the torque support component along the axial direction. For the curved contour of the axially outwardly facing surface section, the predetermined radius of curvature is a radius of the contour on the axial end section of the torque support component as viewed in a longitudinal section of the torque support component along the axial direction.

According to one example embodiment, the radii of curvature of the outwardly curved contour has a predetermined radius of curvature for each surface section, wherein different radii of curvature may be provided at least for each of the radially outwardly facing surface sections.

According to one example embodiment, the predetermined radius of curvature is designed to compensate for a deviation in concentricity between the torque support component and the stationary element. The surface sections with the predetermined radius of curvature are not, according to the present concept, completely in contact with a surface into which the surface section engages, such that, as a result, a certain degree of freedom of movement is permitted and a tilting of the torque support component is prevented. For this purpose, the radii of curvature for predetermined dimensions of the propulsion device may be designed such that a tilting of the torque support component is reduced or prevented. With this measure, the function for limiting torque is reliably enabled.

According to one example embodiment, the stationary element is a housing of the propulsion device and the torque support component may have an outer ring of the gearing, with which a reaction torque of the gearing is introducible into the housing.

According to one example embodiment, the gearing is a strain wave gearing with a housing acting as a stationary element, which may have an inner bush, an outer ring, and a bush bearing, where the inner bush is provided with external toothing and is coupled to a gearing output element, the outer ring is provided with internal toothing and may be a torque support component of the gearing, and the bush bearing is drivable by the electric motor via an input side of the gearing for peripherally deforming the inner bush, wherein the external toothing of the inner bush may have a lower number of teeth than the internal toothing of the outer ring and the peripheral deformation of the inner bush may bring about a rotation of the inner bush relative to the outer ring.

According to one example embodiment, the driven element is coupled to an output gear, which drives at least one driven wheel of the vehicle via a traction mechanism. A gear change mechanism may be provided between the output gear and the at least one driven wheel of the vehicle, which gear change mechanism changes the transmission ratio between the output gear and the at least one driven wheel in a stepped manner.

The traction mechanism may be a chain which is guided via an arrangement of sprockets or chainrings. When the traction mechanism is a chain, the gear change mechanism may be a derailleur system. The gear change mechanism, as a derailleur system, is providable with adjusting devices which guide the traction mechanism, as a chain, on gear wheels having different numbers of teeth. In particular, the derailleur system may have a multitude of sprockets on the driven wheel, which sprockets have different numbers of teeth. Additionally, or alternatively, the derailleur system may have a multitude of chainrings at the crank axle region, which chainrings have different numbers of teeth. The transmission ratio between the output gear of the propulsion device and the driven wheel of the vehicle may be discretely adjustable by guiding the chain onto a predetermined combination of sprockets or chainrings.

Alternatively, the gear change mechanism is a hub gear on the driven wheel of the vehicle. In this case, a gear wheel gearing arrangement may be provided in the region of a hub of the driven wheel of the vehicle, with which gear wheel gearing arrangement the transmission ratio between the driven wheel and a drive element connected to the hub gear is discretely variable. In this case, the traction mechanism may be a chain. Alternatively, the traction mechanism may be a belt, including a toothed belt.

According to one example embodiment, a freewheel unit is in the force transmission path between the gearing output element and the driven element. The freewheel unit between the gearing output element and the driven element may be designed such that force is transmittable from the gearing output element to the driven element for propelling the vehicle in the forward direction.

According to a further example embodiment, a freewheel unit is in the force transmission path between the crank axle output element and the driven element. The freewheel unit between the crank axle output element and the driven element may be designed such that force is transmittable from the crank axle output element to the driven element for propelling the vehicle in the forward direction.

The vehicle in the aforementioned example embodiments may be an e-bike or a pedelec. In particular, the vehicle may be a single-track vehicle having a front wheel and a rear wheel. The driven wheel of the vehicle may be the rear wheel. The propulsion device may be mounted on a frame of the vehicle. The vehicle may also have an electrical energy storage device for supplying electrical energy to the propulsion device. The vehicle may also have a control element with which the rider actuates the gear change mechanism.

### BRIEF DESCRIPTION OF THE DRAWINGS

FIG. 1 shows, in a schematic representation, an example embodiment of the propulsion device in a detailed view; and

FIG. 2 shows, in a schematic representation, the example embodiment of the propulsion device in an overall view.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

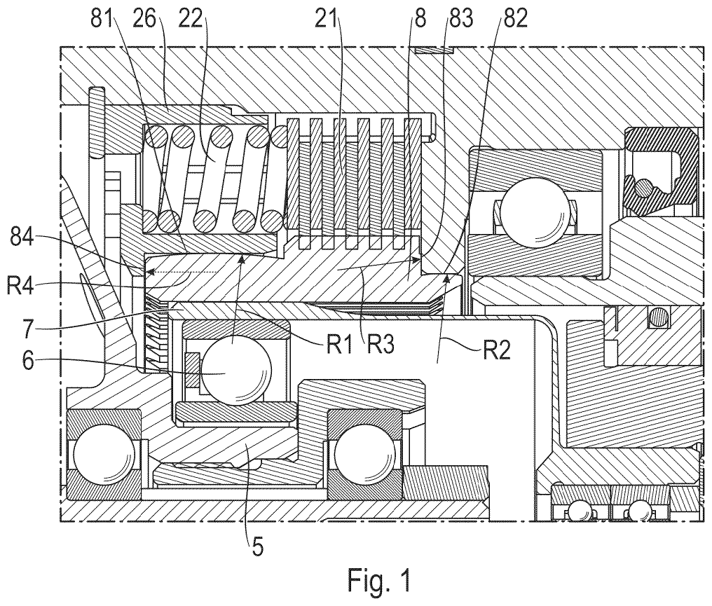

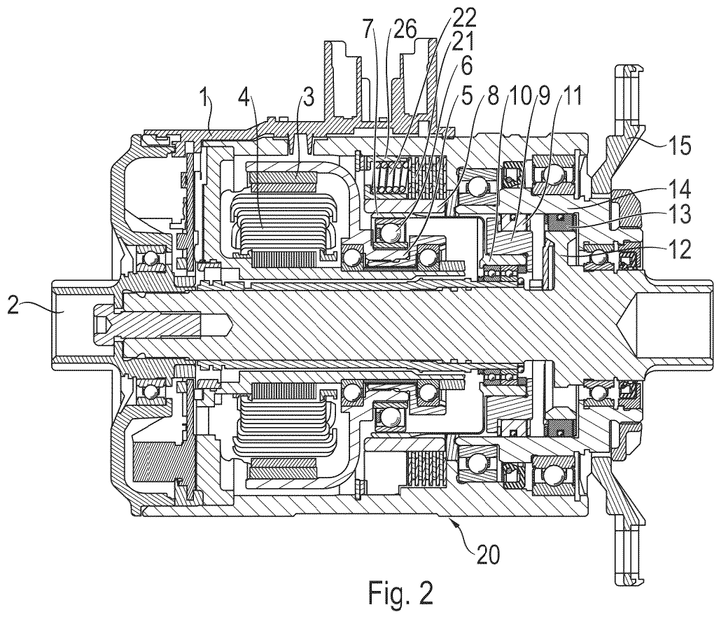

Embodiments are described in the following with reference to the drawings. FIG. 1 is a detailed view of the example embodiment shown in FIG. 2. The fundamental design of the propulsion device is initially explained with reference to FIG. 2. FIG. 2 shows, in a schematic representation, an example embodiment of the propulsion device for a vehicle. In the view shown in FIG. 2, the propulsion device is shown in a cutaway view along an axis of symmetry. The propulsion device of FIG. 2 has a housing 1, which forms an outer periphery of the propulsion device. Fastening means are provided on the housing 1, which fastening means fasten the propulsion device on a vehicle.

The housing 1 accommodates a crank axle 2, which extends through the housing 1 in the axial direction and protrudes from the housing 1 at both axial ends. The crank axle 2 is rotatably mounted inside the housing 1. Pedal cranks (not shown in FIG. 1) are mounted on the crank axle 2, which pedal cranks introduce muscle power into the crank axle 2.

The crank axle 2 has a crank axle output element 12, which is provided as a radial shoulder on the crank axle 2 in the present example embodiment. A first freewheel unit 13 is provided on the outer periphery of the crank axle output element 12, by which the crank axle output element 12 is couplable to a driven element 14 of the propulsion device. In the present example embodiment, the driven element 14 is a sleeve-shaped element, on the inner periphery of which the first freewheel unit 13 is provided.

The driven element 14 is rotatably mounted inside the housing 1 and protrudes axially from the housing, as shown in FIG. 2. An output gear 15 is a gear wheel provided on the driven element 14. A rotation of the driven element 14 therefore brings about a rotation of the output gear 15, which is fixedly connected to the driven element 14.

When the crank axle 2 rotates in a first direction, which is associated with a forward direction of the vehicle, the first freewheel unit 13 transmits the rotation of the crank axle output element 12 onto the driven element 14. The output gear 15 therefore rotates in this case, due to the rotation of the crank axle 2, in the direction associated with the forward travel of the vehicle. When the crank axle 2 rotates in the opposite direction relative to the driven element 14, the first freewheel unit 13 disengages and the rotation of the crank axle 2 is not transmitted onto the output gear 15.

On the left side in FIG. 2, an electric motor is provided in a corresponding hollow space in the housing 1. The electric motor has a stator 4, which is mounted stationarily with respect to the housing 1. The electric motor also has a rotor 3, which is arranged radially outside the stator 4 and is rotatably supported on the housing 1 via a corresponding mounting. The motor with the internal stator 4 and the external rotor 3 is therefore an external-rotor machine. A control device is provided in the region located to the left of the electric motor in FIG. 2, which control device is used to energize the stator 4 of the electric motor from an external energy source. When the stator 4 is energized, the winding of the stator 4 is excited and a rotation of the rotor 3 of the electric motor is induced. This rotation of the rotor 3 of the electric motor is transmitted onto the output element 5 of the electric motor.

A gearing is provided on the right side of the electric motor in FIG. 2. The gearing shown in FIG. 2 is a strain wave gearing in the present example embodiment. The strain wave gearing includes an inner bush 7, on the outer side of which teeth are provided. The inner bush 7 is a sleeve which is flexible in the circumferential direction. An outer ring 8 is arranged outside the inner bush 7, which outer ring acts as a torque support component in the present example embodiment. The outer ring 8 has an internal toothing, which can selectively come into engagement with the external toothing of the inner bush 7. A bush bearing 6 is provided inside the inner bush 7 in the present example embodiment. The bush bearing 6 has an outer ring, which has a non-circular shape. In particular, the outer ring of the bush bearing 6 is elliptical. The inner ring of the bush bearing 6 is coupled to the output element 5 of the electric motor.

When the rotor 3 of the electric motor rotates, the bush bearing 6 is set into rotation. Due to the non-circular shape of the outer ring of the bush bearing 6 and the placement thereof against an inner periphery of the inner bush 7, the inner bush 7 is peripherally deformed. As a characteristic for a strain wave gearing, the inner bush 7 has a number of teeth which is lower than the number of teeth of the internal toothing of the outer ring 8. Therefore, when the outer ring 8 is fixed and the bush bearing 6 rotates, the inner bush 7 is set into rotation. The direction of rotation of the inner bush 7 is opposite to the direction of rotation of the rotor 3 of the electric motor.

Due to the particular strain wave gearing, high transmission ratios of 1:50 or more can be achieved in combination with compact designs. In the present application, an electric motor which has a compact design due to the relatively high nominal rotational speeds is therefore usable. In particular, electric motors having a nominal rotational speed of 5000 rpm or higher are usable. The reduced rotational speed due to the transmission ratio of the gearing is transmitted to a support element 10 of the strain wave gearing, which is rotatably supported on the housing 1 via mountings.

A gearing output element 9 is coupled to a support element 10 provided on the outer ring 8 of the strain wave gearing. The rotation of the support element 10 is transmitted to the gearing output element 9, which is located radially outside the support element 10 of the strain wave gearing. A reaction torque is exerted on the outer ring 8 as a torque support component, which reaction torque is transmitted to the housing 1 as a stationary element.

A second freewheel unit 11 is provided on the radially outer periphery of the gearing output element 9. The second freewheel unit 11 is located between the radial outer peripheral surface of the gearing output element 9 and the radial inner peripheral surface of the driven element 14 of the propulsion device. The second freewheel unit 11 transmits a rotation of the gearing output element 9 associated with forward travel of the vehicle to the driven element 14. A rotation of the gearing output element 9 relative to the driven element 14 in a direction of rotation which is opposite to the direction of rotation associated with forward travel is not transmitted to the driven element 14.

The rotations of the crank axle 2 and of the gearing output element 9 are therefore combined at the driven element 14. In this way, the propulsion device combines the muscle power introduced into the crank axle 2 and the propulsive force output by the rotor 3 of the electric motor.

In the present example embodiment, the output gear 15 is a chainring of a bicycle drive. The output gear 15, which is a chainring, carries a chain (not shown) as a traction mechanism, which is provided with a cassette (also not shown) on a hub of a rear wheel of the vehicle. In one example embodiment, the vehicle has a derailleur system, which can guide the chain on sprockets with different numbers of teeth by a shifting mechanism. The shifting mechanism is actuated by the rider via a control element in the present example embodiment.

During operation of the vehicle, the rider can introduce muscle power into the propulsion device via the crank axle 2, which muscle power is transmitted to the driven element 14 via the first freewheel unit 13. Simultaneously or at least intermittently, the propulsive force of the electric motor is also transmittable to the driven element 14 via the gearing shown in FIG. 1 and via the second freewheel unit 11. In such an operating state, when the rider actuates the control element to change the position of the chain in order to change the transmission ratio between the output gear 15, which is a chainring, and the rear wheel, dynamic changes in rotational speed occur and shocks are regularly caused due to the inertia of the weighted elements. Furthermore, during operation of the vehicle, for example, during braking or while riding on extremely uneven ground, strong oscillations and shocks occur in the drive train between the output gear 15 and the rear wheel of the vehicle.

In order to take these connections into account, the propulsion device has a torque limiting assembly 20, which is shown in FIG. 2. In the example embodiment of FIG. 2, a torque limiting assembly 20 is provided radially outside the outer ring 8 and radially inside the housing 1, which torque limiting assembly has a friction clutch arrangement 21, a preloading element 22, and a holder 26. In the example embodiment of FIG. 2, the outer ring 8 is stationarily held against the housing 1 via the torque limiting assembly 20 and, therefore, fulfils the function as a torque supporting component for absorbing the reaction torque during operation of the propulsion device. The torque limiting assembly 20 has the spring 22, which is accommodated in the holder 26. The spring 22, according to the present example embodiment, has a multitude of spring elements. In particular, the spring 22 includes a multitude of helical compression springs, which are distributed around the periphery of the spring 22. In an alternative example embodiment, a spring 22 formed from one single helical compression spring, disk spring, or the like, is also conceivable. The holder 26 is mounted on the inner periphery of the housing 1. On the other side relative to the axial direction, the friction clutch arrangement 21 is provided on the outer periphery of the outer ring 8, which friction clutch arrangement consists of multiple friction clutch elements, which are concentrically arranged about the outer periphery of the outer ring 8.

The friction clutch elements have stationary friction clutch elements, which are non-rotatably mounted on the housing 1, and movable friction clutch elements, which are fastened on the outer periphery of the outer ring 8. The stationary friction clutch elements and the movable friction clutch elements are stacked on top of one another in alternation. Due to the spring force of the preloading element 22, the stationary friction clutch elements and the movable friction clutch elements of the friction clutch arrangement 21 are compressed, such that the outer ring 8 remains stationary with respect to the housing 1 up to a certain torque. If the maximum torque according to the design specification is exceeded, a slip is generated at the friction clutch arrangement 21, such that the stationary friction clutch elements and the movable friction clutch elements of the friction clutch arrangement 21 can rotate relative to each other and, thus, the outer ring 8 can rotate relative to the housing 1.

It is therefore ensured that, if a maximum support torque is exceeded, the outer ring 8 can rotate relative to the housing 1. This function ensures that the maximum torque acting on the rotor 3 of the electric motor can be limited.

Therefore, for the case in which the support torque which acts on the outer ring 8 exceeds a maximum torque, the torque acting in the force transmission path of the propulsion device is limited. In particular, the elements of the gearing of the propulsion device are protected against overload, such that the operational reliability is improved. For this purpose, the torque limiting assembly 20 and, in particular, the spring force of the preloading element 22 are designed according to the specifications for protecting the elements used for transmitting force in the propulsion device.

In FIG. 1, the concept of an example embodiment of the torque support component is shown. The torque support component in FIG. 1 is the outer ring 8. It is noted that, in alternative example embodiments, the torque support component is a separate element which is connected to the outer ring 8.

As shown in FIG. 1, the outer ring 8 has an axial extent and is rotationally symmetrical. On the axial side of the outer ring 8 located in the region of the holder 26 of the preloading element 22, a radially outwardly facing surface section 81 has an outwardly curved contour. The curved contour is rotationally symmetrical and extends around the outer periphery of the outer ring 8. As shown in FIG. 1, the outwardly curved contour has a radius of curvature R1 which is relative to the contour as viewed in an axial longitudinal section of the outer ring. Furthermore, a radially outwardly facing surface section 82 has an outwardly curved contour on the axial side of the outer ring 8, which outwardly curved contour is supported against a radially inwardly projecting section of the housing 1. The curved contour is also rotationally symmetrical and also extends around the outer periphery of the outer ring 8. As shown in FIG. 1, the outwardly curved contour has a radius of curvature R2 which is relative to the contour as viewed in an axial longitudinal section of the outer ring. The radii of curvature R1 and R2 are different from one another. In particular, the radius of curvature R2 is smaller than the radius of curvature R1.

In addition, surface sections 83 and 84, which are axially supported against the housing 1 and against the holder 26 of the preloading element 22, respectively, are provided on the axially opposite end regions of the outer ring 8. These surface sections 83 and 84 also have contours curved outwardly, namely in the axial direction. The curved contours on the axially outwardly facing surface sections 83 and 84 have a radius of curvature R3 and R4, respectively.

The curved contours on the corresponding surface sections each form peripheral protrusions from the surfaces. The outer ring 8 engages via the surface sections 81, 82, 83, 84 into the respective opposing surfaces and is therefore supported.

Due to the surface sections provided with the curved contours as contact regions for mounting the outer ring 8, an improved degree of freedom for possible manufacturing deviations of the elements of the propulsion device is made possible, such that a tilting of the outer ring 8 is less likely, in particular when a rotation of the outer ring 8 is to take place due to the maximum permissible torque at the torque limiting assembly 20 having been exceeded. The present example embodiment therefore ensures that excessive torque fluctuations, shocks, and the transmission of strong torques due to the inertia of the overall system are transmitted onto the rotor 3 of the electric motor only up to a maximum design specification. The electric motor is therefore improved. At the same time, due to the example embodiment of the outer ring 8 as a torque support component, the functional reliability is improved when the permissible torque in the propulsion device is exceeded.

In the present example embodiments, the propulsion device is used on a bicycle as an e-bike or a pedelec. In alternative example embodiments, the propulsion device is used on a multi-track vehicle, in particular on a vehicle having three or four wheels.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

1 housing
2 crank axle
3 rotor of electric motor
4 stator of electric motor
5 output element of electric motor
6 bush bearing of strain wave gearing
7 inner bush of strain wave gearing
8 outer ring (torque support component)
9 gearing output element
10 support element of strain wave gearing
11 second freewheel unit
12 crank axle output element
13 first freewheel unit
14 driven element
15 output gear
20 torque limiting assembly
21 friction clutch arrangement
22 preloading element
26 holder
81 surface section
82 surface section
83 surface section
84 surface section
R1-R4 radius of curvature

1-15. (canceled)

16. A propulsion device for a vehicle, comprising:
an electric motor (3, 4) for at least intermittently supplying electrical power for propelling the vehicle, the electric motor (3, 4) having an output element (5);
a crank axle (2) for receiving muscle power for at least intermittently propelling the vehicle;
a driven element (14) for delivering propulsive force for propelling the vehicle;
a gearing having a predetermined transmission ratio, an input side of the gearing being coupled to the output element (5) of the electric motor (3, 4), the gearing having a gearing output element (9) at an output side of the gearing, the gearing output element (9) being couplable to the driven element (14);
a crank axle output element (12), the crank axle output element (12) being coupled to the crank axle (2) and couplable to the driven element (14);
a stationary element;
a torque support component having one or more outwardly facing surface sections (81, 82, 83, 84), at least one of the one or more outwardly facing surface sections (81; 82; 83; 84) of the torque support component having an outwardly curved contour; and
a torque limiting assembly (20) for limiting a torque acting in a force transmission path between the electric motor (3, 4) and the driven element (14) to a permissible torque, the torque limiting assembly (20) allowing the torque support component to rotate relative to the stationary element when the torque exceeds a predetermined maximum torque, the predetermined maximum torque being associated with the permissible torque.

17. The propulsion device of claim 16, wherein the stationary element is a housing (1) of the propulsion device for supporting a reaction torque, the torque support component being coupled to the housing (1), the torque limiting assembly (20) being provided in a portion of the force transmission path between the torque support component and the housing (1) to limit a support torque on the torque support component to a predetermined maximum support torque.

18. The propulsion device of claim 17, wherein the torque limiting assembly (20) allows the torque support component to rotate relative to the stationary element when the support torque exceeds the predetermined maximum support torque such that the torque acting on a rotor (3) of the electric motor (3, 4) associated with the reaction torque is limited to the permissible torque.

19. The propulsion device of claim 16, wherein the torque limiting assembly (20) comprises a friction clutch arrangement (21) preloaded by a preloading element (22), a slip being induced in the friction clutch arrangement (21) when a support torque applied at the torque limiting assembly (20) exceeds the predetermined maximum torque such that the torque limiting assembly (20) allows relative motion between the torque support component and the stationary element.

20. The propulsion device of claim 16, wherein the torque support component is rotationally symmetrical, and
wherein the at least one of the one or more outwardly facing surface sections (81; 82; 83; 84) of the torque support component comprises at least one radially outwardly facing surface section (81, 82) on an outer periphery of the torque support component, the at least one radially outwardly facing surface section (81, 82) engaging with an inner periphery of the stationary element via the outwardly curved contour.

21. The propulsion device of claim 16, wherein the torque support component is rotationally symmetrical,
wherein the torque limiting assembly (20) comprises a friction clutch arrangement (21) preloaded by a preloading element (22),
wherein the preloading element (22) of the torque limiting assembly (20) further comprises a holder (26), and
wherein the at least one of the one or more outwardly facing surface sections (81; 82; 83; 84) of the torque support component comprises at least one radially outwardly facing surface section (81, 82) on the torque support component, the at least one radially outwardly facing surface section (81, 82) engaging with a radially inwardly facing surface of the holder (26).

22. The propulsion device of claim 16, wherein the at least one of the one or more outwardly facing surface sections (81; 82; 83; 84) of the torque support component comprises two radially outwardly facing surface sections (81, 82) on an outer periphery of the torque support component, the two radially outwardly facing surface sections (81, 82) being axially spaced apart from each other.

23. The propulsion device of claim 16, wherein the torque support component extends axially, and
wherein the at least one of the one or more outwardly facing surface sections (81; 82; 83; 84) of the torque support component comprises at least one axially outwardly facing surface section (83), the at least one axially outwardly facing surface section (83) engaging with a radial section of the stationary element via the outwardly curved contour.

24. The propulsion device of claim 16, wherein the torque support component extends axially,
wherein the torque limiting assembly (20) comprises a friction clutch arrangement (21) preloaded by a preloading element (22),
wherein the preloading element (22) of the torque limiting assembly (20) further comprises a holder (26), and
wherein the at least one of the one or more outwardly facing surface sections (81; 82; 83; 84) of the torque support component comprises at least one axially outwardly facing surface section (84), the at least one axially outwardly facing surface section (84) engaging with a radial section of the holder (26) via the outwardly curved contour.

25. The propulsion device of claim 16, wherein the at least one of the one or more outwardly facing surface sections (81; 82; 83; 84) of the torque support component comprises two axially outwardly facing surface sections (83, 84) on the torque support component, the two axially outwardly facing surface sections (83, 84) being on opposite axial ends of the torque support component.

26. The propulsion device of claim 16, wherein the outwardly curved contour of at least one of the at least one of the one or more outwardly facing surface sections (81; 82; 83; 84) has a predetermined radius of curvature (R1, R2, R3, R4).

27. The propulsion device of claim 26, wherein the predetermined radius of curvature compensates for a deviation in concentricity between the torque support component and the stationary element.

28. The propulsion device of claim 16, wherein the at least one of the one or more outwardly facing surface sections (81; 82; 83; 84) comprises at least one radially outwardly facing surface section (81, 82), each of the least one radially outwardly facing surface section (81, 82) having a different predetermined radius of curvature from others of the at least one radially outwardly facing surface section (81, 82).

29. The propulsion device of claim 28, wherein the different predetermined radii of curvature compensate for a deviation in concentricity between the torque support component and the stationary element.

30. The propulsion device of claim 16, wherein the stationary element is a housing (1) of the propulsion device and the torque support component comprises an outer ring (8) of the gearing, a reaction torque of the gearing being introducible into the housing (1) via the outer ring.

31. The propulsion device of claim 16, wherein the gearing is a strain wave gearing comprising:
a housing (1), the housing (1) being the stationary element;
an inner bush (7), the inner bush (7) having an external toothing;
a gearing output element (9) coupled to the inner bush (7);
an outer ring (8), the outer ring (8) having an internal toothing, the outer ring (8) being the torque support component, the external toothing of the inner bush (7) having a lower number of teeth than the internal toothing of the outer ring (8); and
a bush bearing (6), the bush bearing (6) being drivable by the electric motor (3, 4) via the input side of the gearing for peripherally deforming the inner bush (7) to rotate the inner bush (7) relative to the outer ring (8).
